(19) United States
(12) Patent Application Publication
(10) Pub. No.: US 2006/0212329 A1
(43) Pub. Date: Sep. 21, 2006

(54) Consolidated management of administrative tasks in an aynchronous, multi-application environment

(75) Inventors: Ian Stuart Lucas, Sammamish, WA (US); Hilal Al-Hilali, Seattle, WA (US); Jonathan Marshall Rowlett, Sammamish, WA (US); Thomas Nicholas Martino, Everett, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/081,367

(22) Filed: Mar. 16, 2005

(51) Int. Cl. G05B 19/418

(52) U.S. Cl. 705/8

(57) ABSTRACT

The systems, methods, and data structure described herein relates to the consolidated management of administrative tasks in an asynchronous, multi-application environment. An information technology (IT) system management application is configured to manage administrative tasks for multiple work centers. Processes associated with the administrative tasks are initiated on the work centers by an IT system management application in an asynchronous manner such that the asynchronous processes can be executed without being actively controlled by the IT system management application. The IT system management application instructs the work centers to provide status information of the asynchronous processes in a specified format. The IT system management application provides a graphical user interface that includes a status pane to publish the status information for monitoring the ongoing administrative tasks. The graphical user interface enables a user to monitor the ongoing administrative tasks through the status pane while performing other actions in other panes of the graphical user interface.

### BACKGROUND

In today's fast-paced business environment, companies are relying more and more on information technology (IT). As a result, the number of interdependent platforms, applications, and technologies in a typical IT infrastructure continues to grow. As IT infrastructures become more complex, the need for an integrated management workspace are increasingly important for IT professionals. The ability to combine management tools from disparate products into a coherent management environment can provide significant productivity benefits for IT professionals. This level of cohesion may be enabled where applications and technologies use a standard generic framework, such as MICROSOFT© Management Console (MMC), to host management utilities. However, although an IT administrator may perform an administrative task on a system using a central management application, the administrator often has to monitor the progress of that task to completion before initiating another task on the same system or a different system.

An efficient way for an IT administrator to concurrently perform and monitor multiple administrative tasks on multiple systems continues to elude those skilled in the art.

### DESCRIPTION OF THE DRAWINGS

These and other features and advantages of the present invention will be better understood from the following detailed description read in light of the accompanying drawings, wherein:

FIG. 1 shows an example system for concurrently managing multiple administrative tasks performed on multiple computing devices.

FIG. 2 illustrates example components of the management console shown in FIG. 1.

FIG. 3 illustrates an example status pane of a graphical user interface for a management console.

FIG. 4 shows an example process for providing status information about multiple administrative tasks controlled by an IT system management application.

FIG. 5 shows an example process for monitoring multiple ongoing administrative tasks handled by an IT system management application.

FIG. 6 shows a screenshot of an example graphical user interface for an IT system management console.

FIG. 7 shows another screenshot of the example graphical user interface illustrated in FIG. 6.

FIG. 8 shows yet another screenshot of the example graphical user interface illustrated in FIG. 6.

FIG. 9 shows still another screenshot of the example graphical user interface illustrated in FIG. 6.

FIG. 10 shows a screenshot of the example graphical user interface when being used to manage multiple, ongoing administrative tasks.

FIG. 11 shows a screenshot of the example graphical user interface when the status pane is in an expanded configuration.

FIG. 12 shows another screenshot of the example graphical user interface when the status pane is in an expanded configuration.

FIG. 13 shows an exemplary computer device for implementing the described systems and methods.

### DETAILED DESCRIPTION

The systems, methods, and data structure described herein relates to the consolidated management of administrative tasks in an asynchronous, multi-application environment. An information technology (IT) system management application is configured to manage administrative tasks for multiple work centers. Processes associated with the administrative tasks are initiated on the work centers by an IT system management application in an asynchronous manner such that the asynchronous processes can be executed without being actively controlled by the IT system management application. The IT system management application instructs the work centers to provide status information of the asynchronous processes in a specified format. The IT system management application provides a graphical user interface that includes a status pane to publish the status information for monitoring the ongoing administrative tasks. The graphical user interface enables a user to monitor the ongoing administrative tasks through the status pane while performing other actions in other panes of the graphical user interface. Thus, multiple administrative tasks can be concurrently perform and monitor on multiple systems in an efficient manner.

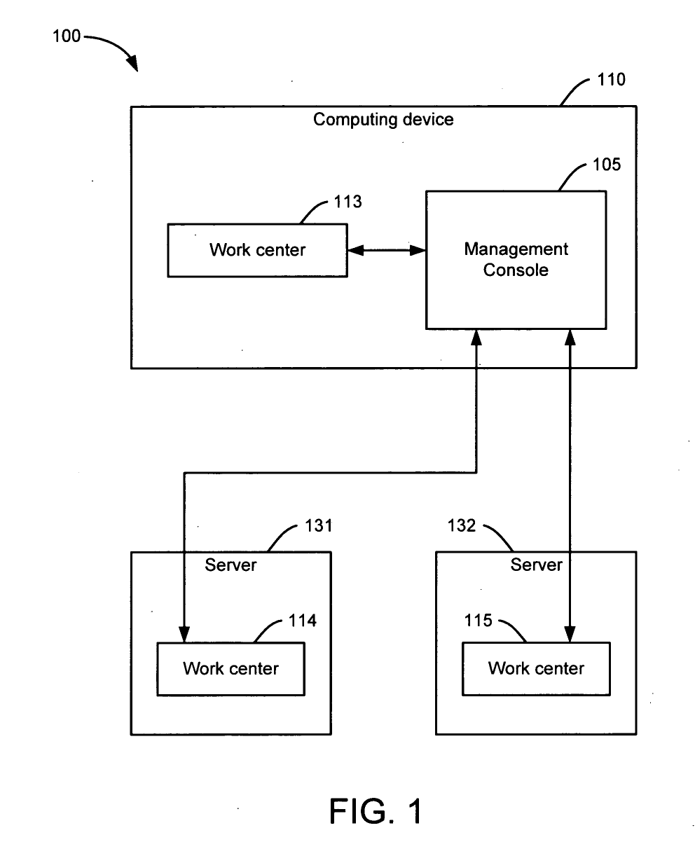

FIG. 1 shows an example system 100 for concurrently managing multiple administrative tasks performed on multiple computing devices. The example system 100 includes management console 105 implemented on computing device 110. Work centers 113-115 are any type of software or hardware components that are administered by management console 105. Typically, work centers 113-115 are configured to provide productivity functionalities for an IT system. Work centers 113-115 are also configured to execute administration-related processes.

Management console 105 is a software module configured to manage hardware and other software modules, such as work centers 113-115. Management console 105 is configured to provide a graphical user interface for handling administrative tasks associated with work centers 113-115. For example, a user, such as a system administrator, may use the graphical user interface provided by management console 105 to initiate, control, and track administrative tasks performed by work centers 113-115. Administrative tasks may include any kind of processes associated with administering software and hardware components of computing devices.

As shown in FIG. 1, management console 105 enables a user to concurrently manage administrative tasks performed by work center 113 on computing device 110, work center 114 on server 131, and work center 115 on server 132. Management console 105 is also configured to initiate, control and track administrative tasks asynchronously with the actual processes performed by work centers 113-115. For example, after a user has initiated an administrative task for a particular work center, management console 105 interacts with that work center to start a process associated with the initiated task and immediately returns control to the user. Since the management console 105 is not synchronized with the process executing by the work center associated with the administrative task, management console 105 enables the user to perform other administrative tasks without having to wait for the completion of the first administrative task.

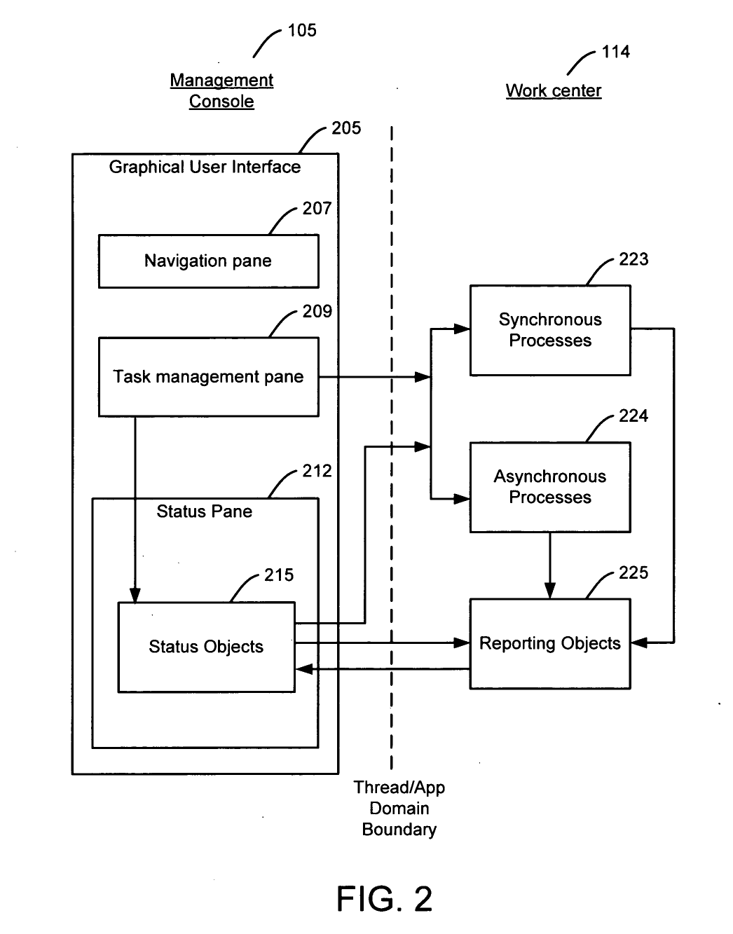

FIG. 2 illustrates example components of management console 105 shown in FIG. 1. As shown in FIG. 2, management console 105 may include a graphical user interface 205 configured to enable a user to interact with management console 105. Graphical user interface 205 is configured to enable the user to concurrently manage multiple ongoing administrative tasks without having to switch context within the interface or to use additional instances of the interface. Graphical user interface 205 may include a navigation pane 207, task management pane 209, and a status pane 212.

Navigation pane 207 may be configured to provide a list of work centers that are managed by management console 105 and to enable a user to select a work center on which to perform an administrative task. Graphical user interface 205 is configured to provide a view on task management pane 209 based on the system selected on navigation pane 207. The view may enable a user to select administrative tasks to be performed on the work center. The available selections may span multiple views. For example, a selection on a particular view may cause another view to be displayed on task management pane 207 that is associated with the selection.

Task management pane 209 of the graphical user interface 205 is configured to provide views that enable a user to initiate and control administrative tasks on the work centers of any device, such as work center 114 on server 131. Each of the views in task management pane 209 is typically associated with a component or a sub-component of a work center administered by management console 105. The view may also be associated with a specific administrative task to be performed. Thus, multiple views may be associated with a particular work center. As shown in FIG. 2, a selection made in task management pane 209 may initiate synchronous processes 223 or asynchronous processes 224 on work center 114.

Synchronous processes 223 are processes that are executed on work center 114 in conjunction with management console 105. For example, when management console 105 interacts with work center 114 to perform a synchronous process, management console 105 enters a wait state until the synchronous process is completed. Typically, only a limited number of actions require synchronous processes 223.

Asynchronous processes 224 are processes that are executed on work center 114 independent of management console 105. Unlike synchronous processes 223, asynchronous processes 224 do not require management console 105 to enter into a wait state. Instead, management console 105 instructs work center 114 to execute asynchronous processes 224 and to provide information about the status of asynchronous processes 224 to management console 105.

In one example, work center 114 may include reporting objects 225 configured to provide status information to management console 105. Each of the reporting objects 225 may be associated with one or more processes initiated by management console 105 and may be configured to provide status information about the processes to management console 105 in specified timing and format. Each of the reporting objects 225 may be associated with one or more of the status objects 215. For example, reporting objects 225 may be configured to provide status information for publishing by the corresponding status objects 215.

Status pane 212 of graphical user interface 205 is configured to provide status information of ongoing administrative tasks that are initiated from graphical user interface 205. In particular, status pane 212 is configured to provide the status information independent of the actions being performed on other panes of graphical user interface 205. Thus, status pane 212 enables a user to keep track of ongoing administrative tasks while performing other actions with graphical user interface 205.

As shown in FIG. 2, graphical user interface 205 includes status objects 215, which are associated with ongoing administrative tasks. Status objects 215 are configured to receive status information from work centers managed by the management console and to publish status information related to ongoing administrative tasks in status pane 212. For example, status objects 215 may receive status information from corresponding reporting objects 225 of work center 114. Status objects 215 may be configured to provide the status information of ongoing administrative tasks in any format, such as graphics, numbers, text, or the like. The content of the status information may include ratio of work, time remaining, arbitrary text strings indicating progress or completion status, or the like.

Graphical user interface 205 is configured to display the status information provided by status objects 215. In particular, graphical user interface 205 is configured to display the status information in status pane 212 in different levels of details to enhance usability. For example, the status information may be grouped by work center to support scalability. Rollup status of all ongoing administrative tasks for each work center may be consolidated in a work center status bar, such as with a summary of task progress and completion status. The health status of administrative tasks for the work center may also be indicated on the corresponding status bar. For example, graphical user interface 205 may be configured to provide an indication of task failure within a consolidated group of administrative tasks for a particular work center. This failure indication serves to immediately alert a user about the failure of an ongoing task while the user is engaged in other administrative actions with management console 105.

Graphical user interface 205 may also be configured with a task specific mechanism to provide quick navigation back to the work center from which a particular task was initiated. This mechanism may be provided through status pane 212 and may be integrated with navigation breadcrumbs to provide navigation back to a relevant context associated with the task of interest. For example, a status bar in status pane 212 for a particular work center may be configured to associate with a view corresponding to that work center in a task management pane of graphical user interface 205. When a user selects one of the status bars in status pane 212, the selection may cause the view associated with the selected status bar to be displayed in the task management pane 209. In this manner, the user may quickly perform other actions from a relevant view associated with the work center, without having to navigate to that view again.

Graphical user interface 205 may also provide a task specific context menu for basic task management operations. The task specific context menu may be provided per task status records in status pane 212. Menu options may include cancel, stop, dismiss (e.g. don't track this task) or the like. Additional associated management operations may be quickly accessible using the navigation mechanisms to return to the initiating work center.

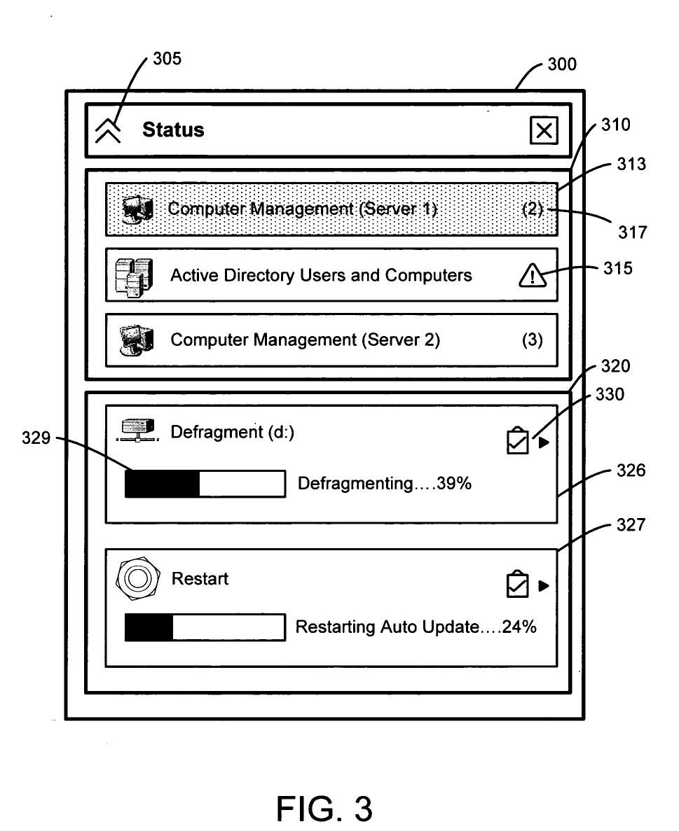

FIG. 3 illustrates an example status pane 300 of a graphical user interface for a management console. Status pane 300 may be located anywhere on and may occupy any portion of the graphical user interface. Status pane 300 may be configured to be in a minimized state to hide the components in the pane. Status pane 300 may also be configured to expand to show the components upon the activation of an expansion trigger 305.

Status pane 300 may include status summary area 310 configured to display a list of status bars associated with work centers that are managed by the management console. As shown in FIG. 3, status summary area 310 includes status bar 313 that corresponds to a server managed by the management console. Status bar 313 may display any type of information about ongoing administrative tasks associated with the corresponding work center. For example, status bar 313 may include a description of the work center corresponding to the status object and an icon that graphically illustrates the work center type. The icon may be changed or animated to reflect the status of the work center. Status bar 313 may also include an indicator 317 that provides a brief status of the ongoing administrative tasks associated with the work center. For example, the indicator may show the number of ongoing administrative tasks that are currently being performed on the work center. The indicator may also be a warning symbol 315, which alerts the user that at least one of the administrative tasks associated with the work center requires attention.

To obtain more status information about administrative tasks associated with a particular work center, the user may select the corresponding status bar to cause additional status information to be displayed in status information display area 320. In FIG. 3, status bar 313 has been highlighted, indicating that the bar has been selected. In status information area 320, status information about ongoing administrative tasks that are associated with the work center indicated by status bar 313 are displayed. As shown in FIG. 3, status boxes 326 and 327 that are associated with two ongoing administrative tasks are displayed in status information display area 320. Status box 326 indicates that one of the administrative tasks is a defragment task for a backup drive. Status box 327 indicates that the other administrative task is a restarting task for an auto update process.

Status box 326 may include many types of information and functionalities. For example, status box 326 may include information about the progress of the administrative task in any format, such as text description, status bar 329, other graphical status representations or the like. Status box 326 may also enable the user to perform certain actions related to the administrative task. For example, the user may select a menu of the available actions by activating action menu trigger 330. The menu may include any type of actions, such as dismiss, cancel, stop, restart, or the like.

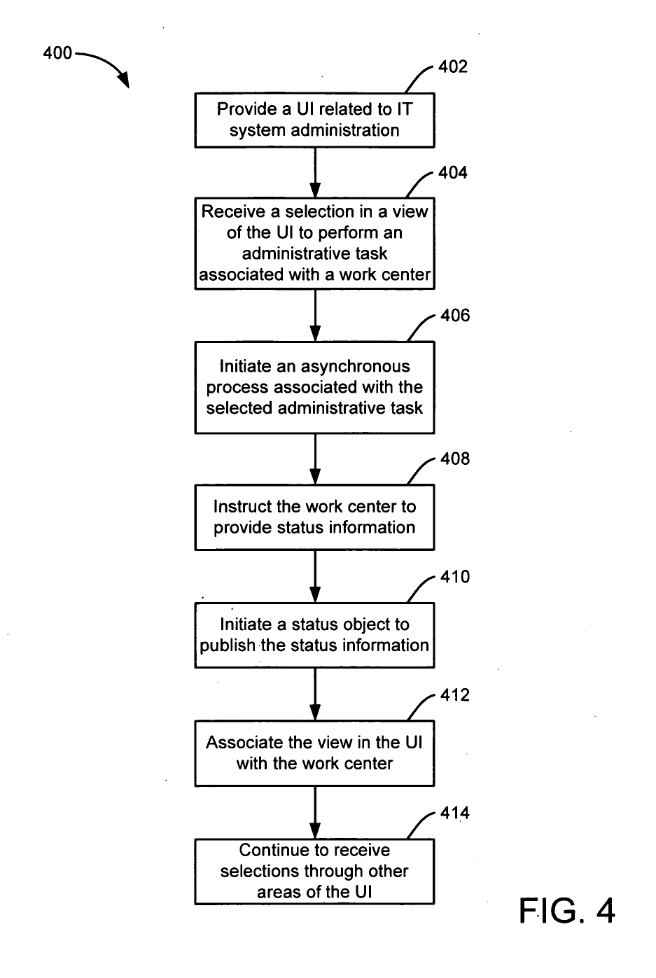

FIG. 4 shows an example process 400 for providing status information about multiple administrative tasks controlled by an IT system management application, such as management console 105 shown in FIG. 1. At block 402, a graphical user interface related to IT system administration is provided by the IT system management application. At block 404, a selection to perform an administrative task associated with a work center is received. The selection may be made by a user from a view on a task management panel of the graphical user interface.

At block 406, an asynchronous process associated with the selected administrative task is initiated on the work center. At block 408, the work center is instructed to provide status information related to the initiated process to the IT system management application. The instructions may include the manner in which the status information is to be provided, such as the kind of information, the frequency, the format, or the like.

At block 410, a status object is initiated to publish the status information on the graphical user interface. The status object may publish information in a specific area of the graphical user interface, such as status pane 212 shown in FIG. 2. At block 412, the view in the graphical user interface from which the selection was made is associated the work center. For example, the view may be associated with a status bar in the status pane 212 where the status bar corresponds to the work center. At block 414, process 400 continues to receive selections through other areas of the UI. For example, a user may initiate other tasks from the view in the task management panel while monitoring ongoing administrative tasks indicated in the status pane of the graphical user interface.

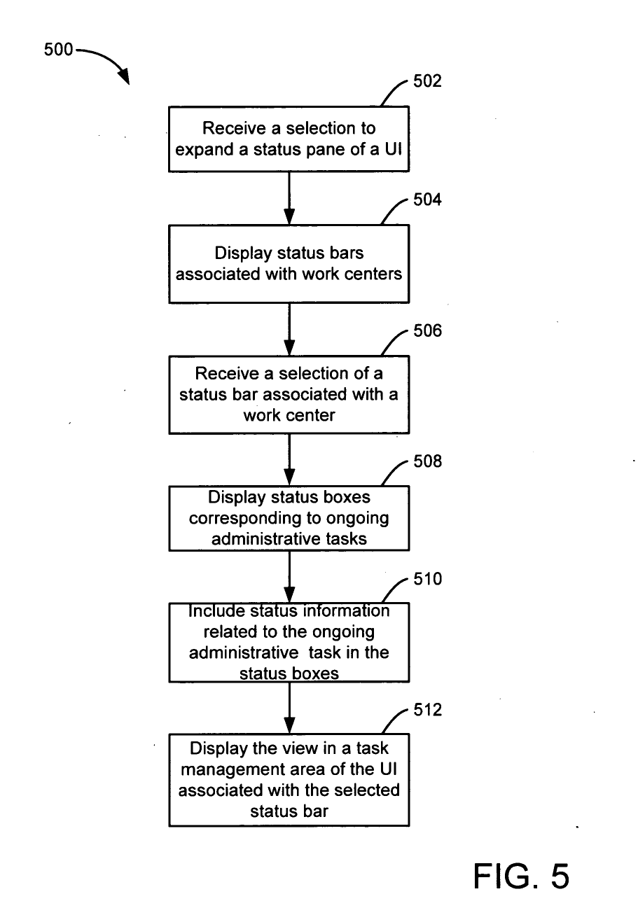

FIG. 5 shows an example process 500 for monitoring multiple ongoing administrative tasks handled by an IT system management application. At block 502, a selection is received to expand a status pane of a graphical user interface provided by the IT system management application. At block 504, status bars corresponding to work centers with ongoing administrative tasks are displayed in the expanded status pane. At block 506, a selection of one of the status bar associated with a particular work center is received. At block 508, status boxes associated with the selected status bar is displayed in the status pane. Each status box corresponds to an administrative task associated with the work center. At block 510, status information related to an ongoing administrative task is included in each status box. At block 512, a view in a task management area of the graphical user interface associated with the selected status bar is displayed. The user may make other selections associated with the work center that corresponds to the view.

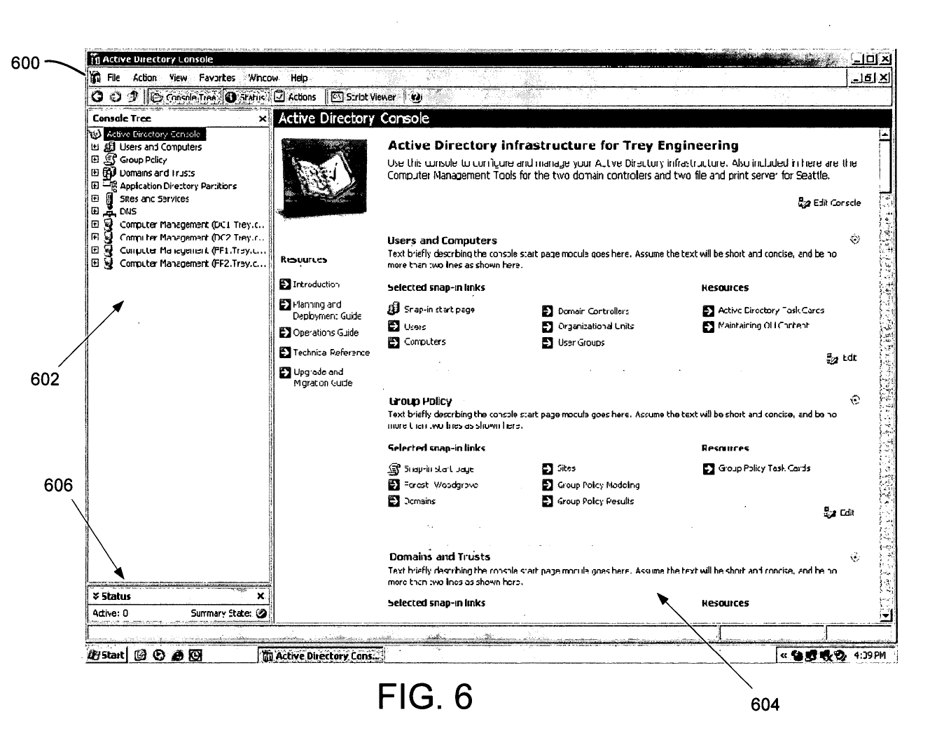

FIG. 6 shows a screenshot of an example graphical user interface 600 for an IT system management console. Graphical user interface 600 may include one or more areas for displaying different information. For example, graphical user interface 600 may include navigation pane 602, task management pane 604, and status pane 606. As shown in FIG. 6, status pane 606 is in a minimized configuration and shows that no administrative task is currently active.

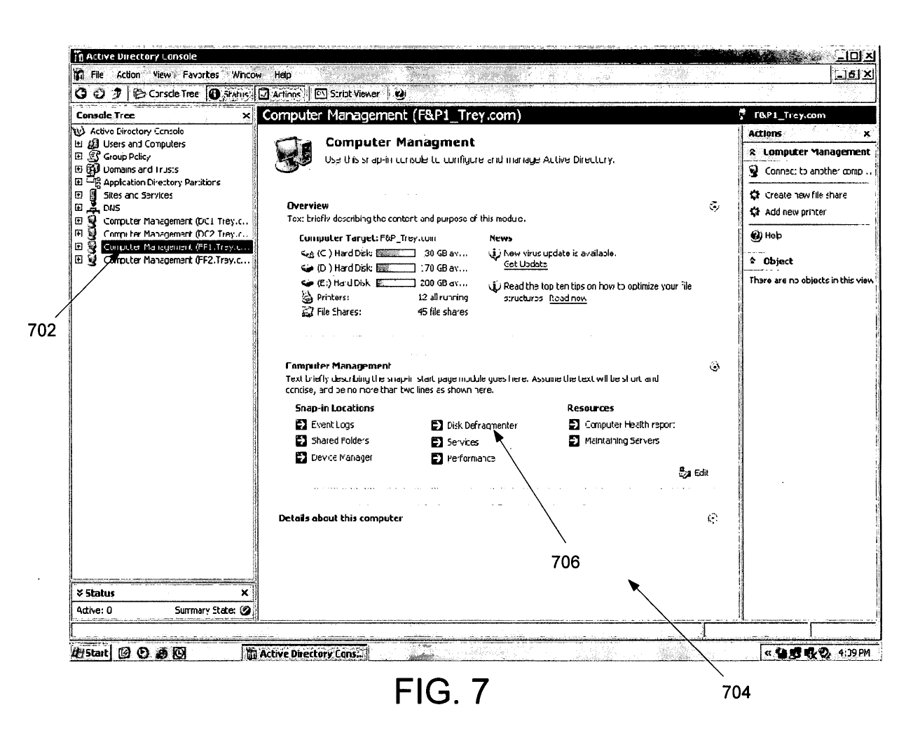

FIG. 7 shows another screenshot of the example graphical user interface 600 illustrated in FIG. 6. As shown in FIG. 7, server FP1, which includes a particular work center managed by the IT system management console, has been selected, as illustrated by indicator 702. In response to the selection of server FP1, task view 704 is displayed in the task management pane. Task view 704 may include multiple tasks that can be initiated by the IT system management console. For example, task view 704 includes disk defragmenter trigger 704. A user may activate disk defragmenter trigger 704 to defrag a disk on server FP1. The user may be prompted to make other selections to further specify the defragment task.

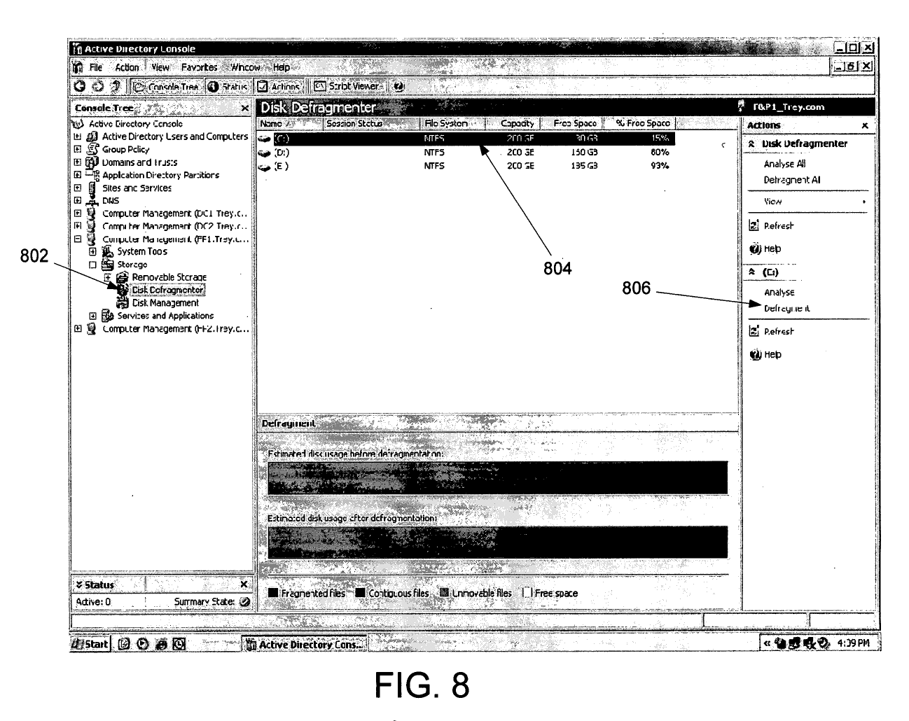

FIG. 8 shows yet another screenshot of the example graphical user interface 600 illustrated in FIG. 6. The screenshot in FIG. 8 shows a view in the task management pane after disk defragmenter trigger 704 has been activated. The view is associated with a disk defragmenter for server FP1, as shown by indicator 802 in the task management pane. The user may make further selection in the navigation pane to initiate and control administrative tasks made available on the view. In FIG. 8, a user has selected the “C:” drive of server FP1, as shown by indicator 804. The user may initiate a disk defragment task by activating trigger 806 in the actions pane.

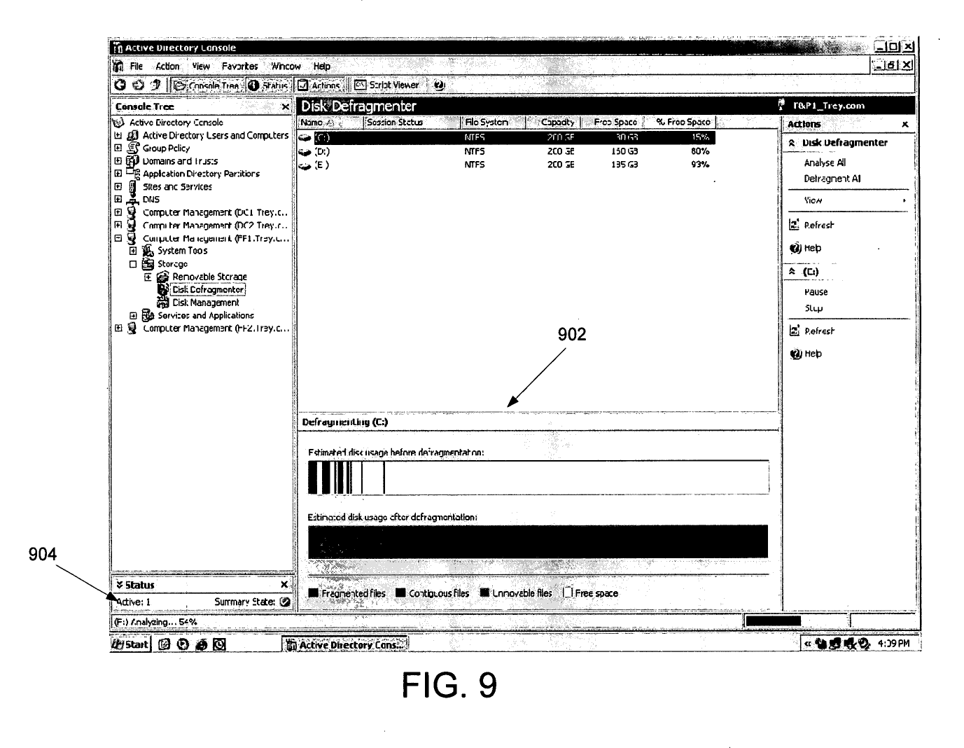

FIG. 9 shows still another screenshot of the example graphical user interface 600 illustrated in FIG. 6. This screenshot shows the view in the task management pane after the disk defragment task has been initiated by activating trigger 806. As shown in FIG. 9, the view includes an area 902 that illustrates the progress of the defragment task. The status pane of graphical user interface 600 is shown to be in a minimized state. The summary bar 904 in the status pane indicates the defragment task as an active task.

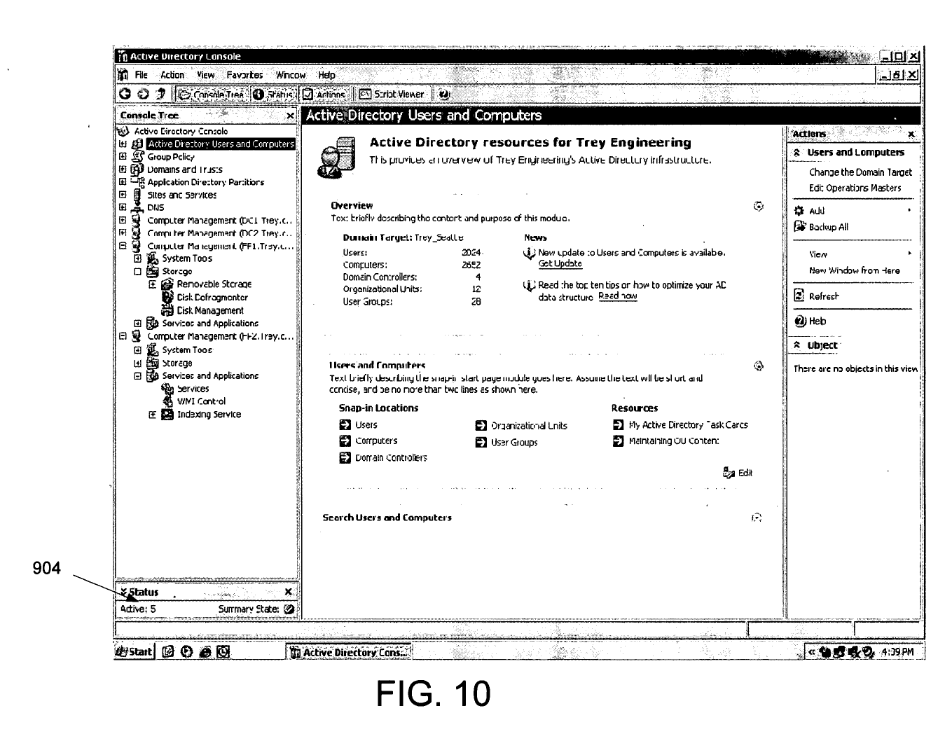

FIG. 10 shows a screenshot of the example graphical user interface 600 illustrated in FIG. 6 when being used to manage multiple, ongoing administrative tasks. Summary bar 904 in status pane indicates that there are five ongoing administrative tasks that are active. These administrative tasks are asynchronous with the IT system management application and can be concurrently managed and while performing other administrative tasks. For example, graphical user interface 600 does not have to monitor the defragment task in area 902 until the task is finished.

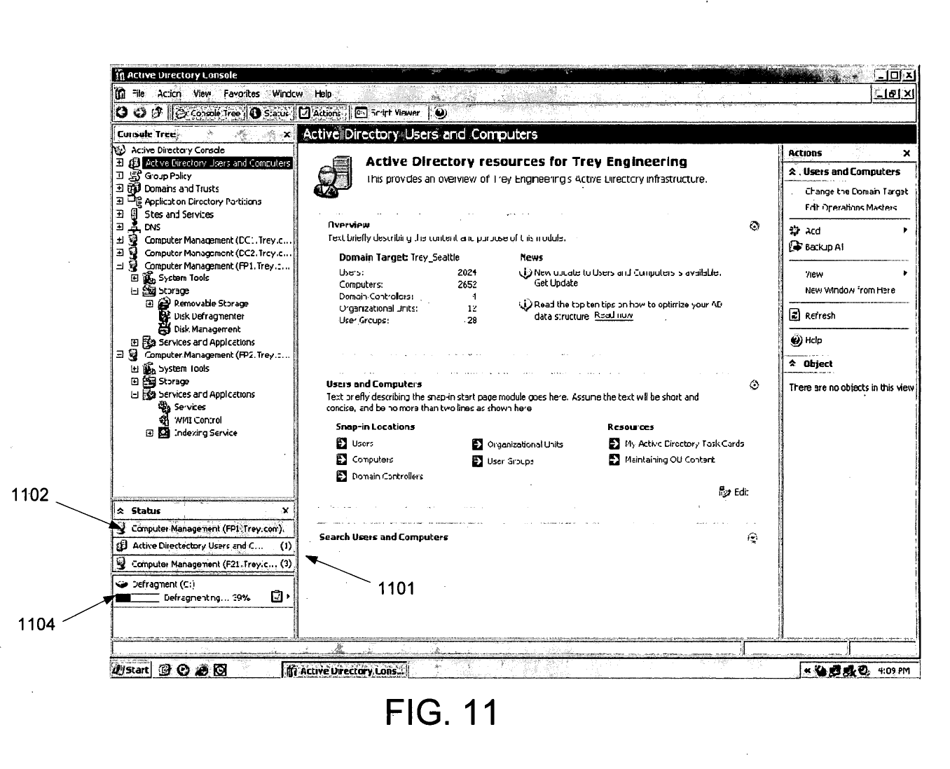

FIG. 11 shows a screenshot of the example graphical user interface 600 illustrated in FIG. 6 when the status pane is in an expanded configuration. The status pane of graphical user interface 600 includes status bars 1101, each associated with a system managed by an IT system management application. As shown in FIG. 11, the status pane includes status bar 1102 associated with Server FP1. Status bar 1102 has been selected as indicated by the highlighting. In response to the selection, status box 1104 is activated and includes status information of ongoing administrative tasks of the work center associated with status bar 1102. In this example, the administrative task is a disk defragment task. It is to be appreciated that a user can perform other administrative tasks using graphical user interface 600, while concurrently monitoring and controlling administrative tasks with the same graphical user interface using status bars in the status pane.

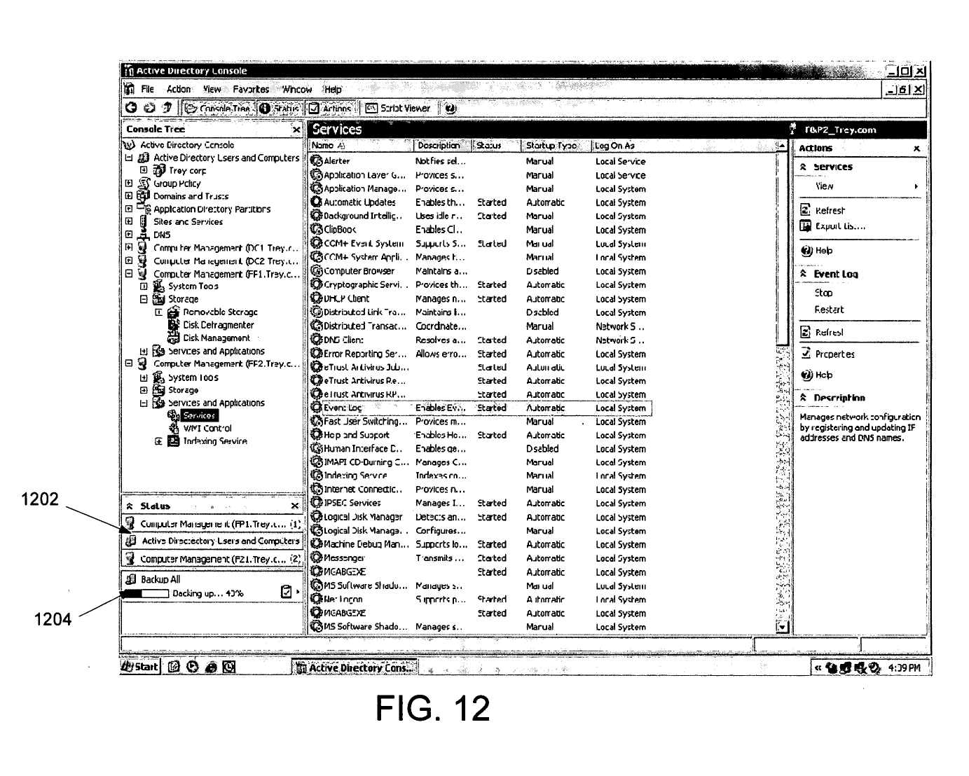

FIG. 12 shows another screenshot of the example graphical user interface 600 illustrated in FIG. 6 when the status pane is in an expanded configuration. As shown in FIG. 12, the navigation pane and the task management pane show that graphical user interface 600 of the IT system management application is currently enabling a user to perform administrative tasks for services on Server FP2. Concurrently, graphical user interface 600 also enables the user to monitor ongoing administrative tasks in the status pane. Status bar 1202 has been highlighted, which indicates that the user has selected to view the administrative tasks associated with the Active Directory. Information box 1204 shows that the ongoing administrative task for the work center is a backup task.

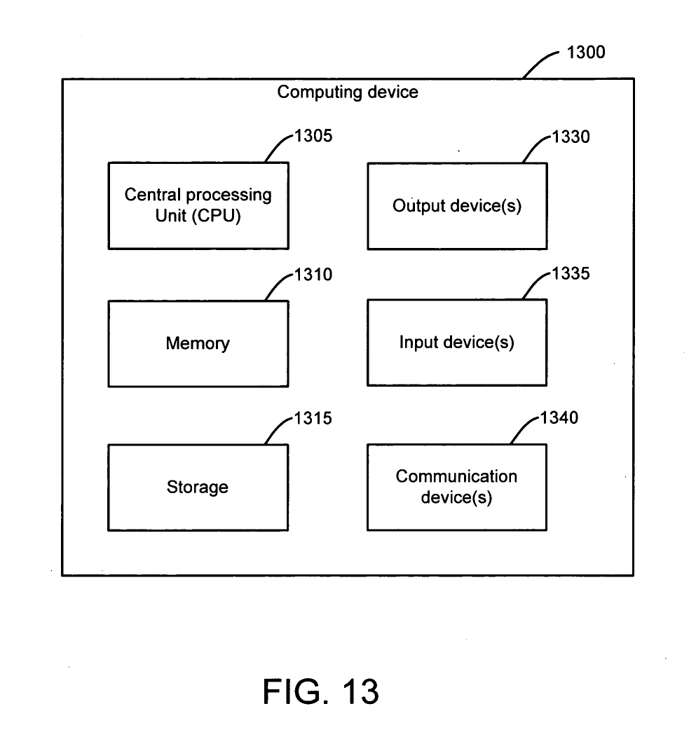

FIG. 13 shows an exemplary computer device 1300 for implementing the described systems and methods. In its most basic configuration, computing device 1300 typically includes at least one central processing unit (CPU) 1305 and memory 1310.

Depending on the exact configuration and type of computing device, memory 1310 may be volatile (such as RAM), non-volatile (such as ROM, flash memory, etc.) or some combination of the two. Additionally, computing device 1300 may also have additional features/functionality. For example, computing device 1300 may include multiple CPU's. The described methods may be executed in any manner by any processing unit in computing device 1300. For example, the described process may be executed by both multiple CPU's in parallel.

Computing device 1300 may also include additional storage (removable and/or non-removable) including, but not limited to, magnetic or optical disks or tape. Such additional storage is illustrated in FIG. 13 by storage 1315. Computer storage media includes volatile and nonvolatile, removable and non-removable media implemented in any method or technology for storage of information such as computer readable instructions, data structures, program modules or other data. Memory 1310 and storage 1315 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 1300. Any such computer storage media may be part of computing device 1300.

Computing device 1300 may also contain communications device(s) 1340 that allow the device to communicate with other devices. Communications device(s) 1340 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 1300 may also have input device(s) 1335 such as keyboard, mouse, pen, voice input device, touch input device, etc. Output device(s) 1330 such as a display, speakers, printer, etc. may also be included. All these devices are well know in the art and need not be discussed at length.

While the preferred embodiment of the invention has been illustrated and described, it will be appreciated that various changes can be made therein without departing from the spirit and scope of the invention.

1) In a computing device having a management application configured to manage a plurality of work centers, the management application providing a graphical user interface for administering the devices, a method of configuring the graphical user interface, comprising:
providing a task management pane on the graphical user interface for selecting to perform administrative tasks on the work centers;
providing a status pane on the graphical user interface;
displaying status bars in the status pane, each status bar associated with at least one of the work centers;
identifying ongoing administrative tasks associated with at least one of the status bar;
determining status information for the identified administrative tasks; and
publishing the status information associated with the selected status bar in the status pane on the graphical user interface asynchronously with other actions of the management application.

2) The method as recited in claim 1, further comprising:
identifying a view in the task management pane associated with at least one of the status bars, the view providing selections to perform administrative tasks on the work center associated with the at least one status bar; and
in response to selecting the at least one status bar, displaying the view in the task management pane.

3) The method as recited in claim 2, further comprising:
displaying information boxes associated with the selected status bar in the status pane, each of the information boxes corresponding to at least one of the ongoing administrative tasks being performed on the work center associated with the selected status bar; and
publishing the status information for each of the ongoing administrative tasks in the corresponding information box.

4) The method as recited in claim 3, wherein the status information includes at least one of text or graphical status representation.

5) The method as recited in claim 3, further comprising:
identifying a second view in the task management pane associated with at least one of the ongoing administrative tasks, the second view being the view from which the at least one ongoing administrative task was initiated; and
in response to selecting the information box associated with the at least one information box, displaying the second view in the task management pane.

6) The method as recited in claim 3, further comprising providing options selectable from the information box, the selectable options corresponding to actions that can be performed on the ongoing administrative task associated with the information box.

7) The method as recited in claim 6, wherein the actions include at least one of dismiss, cancel, stop, pause, resume, or restart.

8) The method as recited in claim 1, further comprising displaying on at least one of the status bars at least one of a description of the work center corresponding to the at least one status bar, an icon graphically illustrating the work center, or animated graphics indicating the status of the work center.

9) The method as recited in claim 1, further comprising displaying on at least one of the status bar an indicator related to the status of ongoing administrative tasks associated with the at least one status bar.

10) The method as recited in claim 8, wherein the indicator includes at least one of the number of ongoing administrative tasks currently being performed on the work center, or a warning symbol alerting that at least one of the ongoing administrative tasks associated with the work center requires attention.

11) One or more computer-readable media encoded with the method as recited in claim 1.

12) A computing device configured to perform the method recited in claim 1.

13) One or more device-readable media having device-executable instructions for performing steps comprising:
providing a graphical user interface associated with a management application configured to manage a plurality of work centers;
receiving a selection to perform an administrative task associated with a first work center;
initiating a process associated with the selected administrative task on the first work center, the process being executed asynchronous with the management application;
instructing the first work center to provide status information associated with the process to the management application; and
enabling the selection to perform another administrative task while the first administrative task is being performed.

14) The one or more device-readable media as recited in claim 13, wherein the management application and the first work center are executing on different computing devices.

15) The one or more device-readable media as recited in claim 13, further comprising:
instantiating a status object associated with the first work center on the graphical user interface;
receiving status information associated with the process from the first work center; and
displaying the status information when the status object is selected.

16) A computing device configured to read the one or more device-readable media and to perform the device-executable instructions as recited in claim 13.

17) An information technology (IT) system comprising:
a plurality of work centers configured to provide productivity functionalities for the IT system; and
a management application configured to initiate administrative processes on the work centers, the administrative processes being executed asynchronously with the management application, the management application being further configured to instruct the work centers to provide status information related to the initiated administrative process and to monitor the initiated processes with the status information while simultaneously enabling new administrative processes to be initiated.

18) The IT system as recited in claim 17, wherein the management application provides a graphical user interface for interacting with a user and wherein the graphical user interface is configured to display the status information related to the initiated administrative processes and to simultaneously receive selections to initiate new administrative processes.

19) The IT system as recited in claim 18, wherein the management application is configured initiate a status object for each work center and wherein the status object is configured to receive the status information associated with administrative processes executing on the work center and to display the status information on the graphical user interface.

20) The IT system as recited in claim 19, wherein each work center includes a reporting object corresponding to a status object in the management application and wherein the reporting object is configured to provide to the status object status information of administrative processes executing on the work center.
